(19) United States
(12) Patent Application Publication
(10) Pub. No.: US 2010/0309154 A1
(43) Pub. Date: Dec. 9, 2010

(54) TWO-DIMENSIONAL INPUT DEVICE, CONTROL DEVICE AND INTERACTIVE GAME SYSTEM

(75) Inventors: Cho-Yi LIN, Hsinchu (TW); Chih-Hung Lu, Hsinchu (TW)

Correspondence Address: LanWay IPR Services, P.O. Box 220746, Chantilly, VA, 20153, US

(73) Assignee: PixArt Imaging Inc.

(21) Appl. No.: 12/757,976

(22) Filed: Apr. 10, 2010

(30) Foreign Application Priority Data
Jun. 8, 2009 (TW) 098119048

(51) Int. Cl. G06F 3/041

(52) U.S. Cl. 345/173

(57) ABSTRACT

A two-dimensional input device, a control device and an interactive game system are provided. The control device is suitable for communicating with a game console which performing a game program. The control device includes a two-dimensional input device and a remote controller. The two-dimensional input device includes a touch panel which showing a pattern corresponding to the game program. The two-dimensional input device outputs a two-dimensional coordinate data when the pattern was touched. The remote control receives the two-dimensional coordinate data by a first communication method and outputs the two-dimensional coordinate data by a second communication method. Wherein, the game console receives the two-dimensional coordinate data and performs it with the game program.

### CROSS-REFERENCE TO RELATED APPLICATIONS

This application is based upon and claims the benefit of priority from the prior Taiwanese Patent Application No. 098119048, filed Jun. 8, 2009, the entire contents of which are incorporated herein by reference.

### BACKGROUND

The present invention relates to a technology of the touch control field. More particularly, the present invention relates to a specific game program's pattern displayed by a plugboard or itself on a two-dimensional input device, a control device and an interactive game system.

The pleasure of video games has started ever since its launch worldwide. Notwithstanding the thriving games which created entertainment, they failed to bring interactions between people in real life. This is especially found in role-playing games, which were implemented with enhanced 3D images yet without real interactions.

For this reason, Nintendo Inc. presented the all new 2^{nd} generation home-use game console, the Wii. The main idea of Wii is to bring true interactions between people in order that players will have on-site sensations. The Nintendo Wii console is mainly controlled via motion and acceleration by two controllers that acquire the speed, gesture, and etc. of the player. Nonetheless, the two controllers in utilization are usually controlled with motion and acceleration only, which make it difficult for games that are operated in a stationary manner.

### BRIEF SUMMARY

The present invention relates to a control device for disposing a two-dimensional input device and a remote controller to be a right joystick and a light joystick. Therefore, a specific game program's pattern can be displayed by a plugboard or itself on the two-dimensional input device for collocating specific game program.

The present invention relates to a two-dimensional input device which can communicate with the game console directly. Therefore, the user can not only play the existed game program but also the specific game which needs to collocate specific game pattern.

In one aspect of the present invention, a control device is provided. The control device is suitable for communicating with a game console which performing a game program. The control device comprises a two-dimensional input device and a remote controller. The two-dimensional input device has a touch panel displaying a pattern corresponding to the game program. The two-dimensional input device generates a two-dimensional coordinate data when being touched and outputs the two-dimensional coordinate data. The remote controller receives the two-dimensional coordinate data by a first communication method and outputs the two-dimensional coordinate data to the game console by a second communication method. Wherein, the game console receives the two-dimensional coordinate data and performs a game program according to the two-dimensional coordinate data.

In an embodiment of the present invention, the two-dimensional input device further comprises a touch sense module, a first memory, a first microprocessor and a first connection module. The touch sense module is coupled to the touch panel for generating a sense signal according to touch of the touch panel and outputting the sense signal. The first memory stores the pattern. The first microprocessor is coupled to the sense module for performing a coordinate operation to generate a two-dimensional coordinate data and output the two-dimensional coordinate data when receiving the sense signal. The first connection module is coupled to the first microprocessor for receiving the two-dimensional coordinate data and outputting the two-dimensional coordinate data to the remote controller by the first communication method.

In an embodiment of the present invention, the first connection module can be replaced with a third communication module for communicating with a remote controller by a wireless transmission method.

In another aspect of the present invention, the control device is suitable for communicating with a game console which performing a game program. The control device comprises a game plugboard, a two-dimensional input device and a remote controller. The game console performs the game program. The game plugboard has a pattern corresponding to the game program. The two-dimensional input device comprises a touch panel disposed under the game plugboard for generating a two-dimensional coordinate data and outputting a two-dimensional coordinate data when the pattern is touched. The remote controller receives the two-dimensional coordinate data and outputs the two-dimensional coordinate data to the game console by a second communication method. Wherein, the game console receives the two-dimensional coordinate data and performs the game program according to the two-dimensional coordinate data.

In another aspect of the present invention, a two-dimensional input device suitable for communicating with a game console which performing a game program is provided. The two-dimensional input device comprises a touch panel, a touch sense module, an operation module, an acceleration sensor, an optical image processing circuit and a core circuit. The touch panel displays a pattern corresponding to the game program. The touch sense module is coupled to the touch panel for generating a sense signal according to touch of the touch panel and outputting the sense signal. The operation module generates an operation instruction according to operation of user and outputs the operation instruction. The acceleration sensor generates an acceleration data according to motion of the remote controller and outputs the acceleration data. The optical image processing circuit captures outside light emitted for filtering and performing an image processing to obtain a motion data and output the motion data. The core circuit is coupled to the touch panel, the touch sense module, the optical image processing circuit, the operation module and the acceleration sensor for receiving the sense signal, the acceleration data and the motion data, wherein the core circuit performs a coordinate operation with the sense signal to obtain a two-dimensional coordinate data and output the two-dimensional coordinate data, the operation instruction, the acceleration data and the motion data to the game console by a communication method.

In another aspect of the present invention, a two-dimensional input device suitable for communicating with a game console which performing a game program is provided. The two-dimensional input device comprises a game plugboard, a touch panel, a touch sense module, an operation module, an acceleration sensor, an optical image processing circuit and a core circuit. The game plugboard has a pattern corresponding to the game program. The touch panel is disposed under the game plugboard. The touch sense module is coupled to the touch panel for generating a sense signal according to touch of the pattern and outputting the sense signal. The operation module generates an operation instruction according to operation of user and outputs the operation instruction. The acceleration sensor generates an acceleration data according to motion of the remote controller and outputs the acceleration data. The optical image processing circuit captures outside light emitted for filtering and performing an image processing to obtain a motion data and output the motion data. The core circuit is coupled to the touch sense module, the optical image processing circuit, the operation module and the acceleration sensor for receiving the sense signal the acceleration data and the motion data, wherein the core circuit performs a coordinate operation with the sense signal to obtain a two-dimensional coordinate data and output the two-dimensional coordinate data, the operation instruction, the acceleration data and the motion data to the game console by a communication method.

In the present invention, the two-dimensional input device is disposed in the control device so that user can input data interacting with the game program on the two-dimensional input device due to a specific game program's pattern can be displayed by a plugboard or itself on the two-dimensional input device. Therefore, it can provide more diversification selection of the game program to user. Besides, the two-dimensional input device can communicate with the game console alone so that operation complex can be reduced and play more game programs.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic diagram of an interactive game system of an embodiment of the present invention.

FIG. 2 is a schematic circuit block diagram of a two-dimensional input device and a remote controller of an embodiment of the present invention.

FIG. 3 is a schematic circuit block diagram of a two-dimensional input device and a remote controller of another embodiment of the present invention.

FIG. 4 is a schematic circuit block diagram of a two-dimensional input device and a remote controller of another embodiment of the present invention.

FIG. 5 is a schematic circuit block diagram of a two-dimensional input device and a remote controller of another embodiment of the present invention.

FIG. 6 is a schematic diagram of an interactive game system of another embodiment of the present invention.

FIG. 7 is a schematic circuit block diagram of a two-dimensional input device of FIG. 6 of the present invention.

FIG. 8 is a schematic circuit block diagram of another two-dimensional input device of FIG. 6 of the present invention.

FIG. 9 is a schematic of disposed position of the game plugboard and the two-dimensional input device of an embodiment of the present invention.

FIG. 10 is a schematic diagram of the two-dimensional input device applying with optical sense of an embodiment of the present invention.

FIG. 11 is a schematic diagram of the two-dimensional input device applying with optical sense of another embodiment of the present invention.

FIG. 12 is a schematic diagram of the two-dimensional input device applying with optical sense of other embodiment of the present invention.

FIG. 13 is a schematic diagram of the two-dimensional input device applying with resistive sense of other embodiment of the present invention.

FIG. 14 is a schematic diagram of the two-dimensional input device applying with capacitance sense of other embodiment of the present invention.

FIG. 15 is a schematic diagram of the two-dimensional input device applying with surface acoustic wave sense of other embodiment of the present invention.

### DETAILED DESCRIPTION

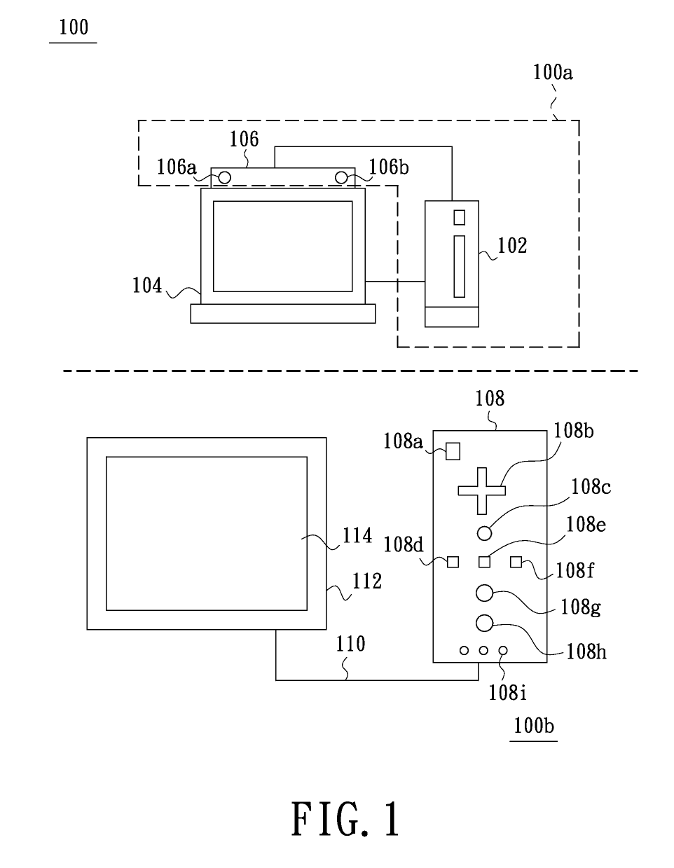

Please refer to FIG. 1, it is a schematic diagram of an interactive game system of an embodiment of the present invention. The interactive game system 100 comprises a main game device 100a, a control device 100b and a display 104, wherein the main game device 100a comprises a game console 102 and an illuminant emitting module 106. The control device 100b comprises a remote controller 108, a cable 110 and a two-dimensional input device 112. Wherein, the two-dimensional input device 112 comprises a touch panel 114.

In the embodiment, the game console 102 is coupled to the display 104 and the illuminant emitting module 106. The game console 102 can be inputted a game disc or be interrupted a memory card or a memory plate. The game program can be burned or stored in a programmable memory of the game console 102. The game console 102 performs the game program after being enabled and outputs a display frame of the game program to the display 104. Besides, the game console 102 also outputs a light emitting signal to the illuminant emitting module 106 after being enabled. Wherein, one of ordinary skill in the art should know that the game console 102 can be WII game console. The present invention, however, is not limited thereto.

The display 104 receives and displays the display frame of the game program. The illuminant emitting module 106 has at least an illuminant. In the present invention, the illuminants are two and labeled as 106a and 106b, but the illuminant amount is decided by a request of design. The present invention, however, is not limited thereto. The illuminants 106a and 106b are enabled to emit light when the illuminant emitting module 106 receives the illuminant emitting signal. The illuminants 106a, 106b are enabled by the illuminant emitting module 106 after receiving the illuminant emitting signal. Wherein, light emitted by the illuminants 106a, 106b can be infrared ray. The present invention, however, is not limited thereto.

The remote controller 108 has a plurality of operation keys 108a, 108b, 108c, 108d, 108e, 108f, 108g, 108h and an indicator Light 108i. The operation key 108a can be a power switch which can enable the remote controller 108 after being pressed; contrariwise, the remote controller 108 cab be disabled when the operation key 108a is pressed again. The operation key 108b is a crisscross key for providing direction selection to user. Besides, the operation key 108b also can be circle key or four independent operation keys indicating different direction respectively. The present invention, however, is not limited thereto. The operation keys 108c, 108g and 108h can have its corresponding function and be a selection key, a menu key and a start key respectively. The indicator Light 108i is used to indicate status of the remote controller 108. For example, each indicator Light 108i indicates a serial number corresponding to the game console 102 if there are several remote controllers 108.

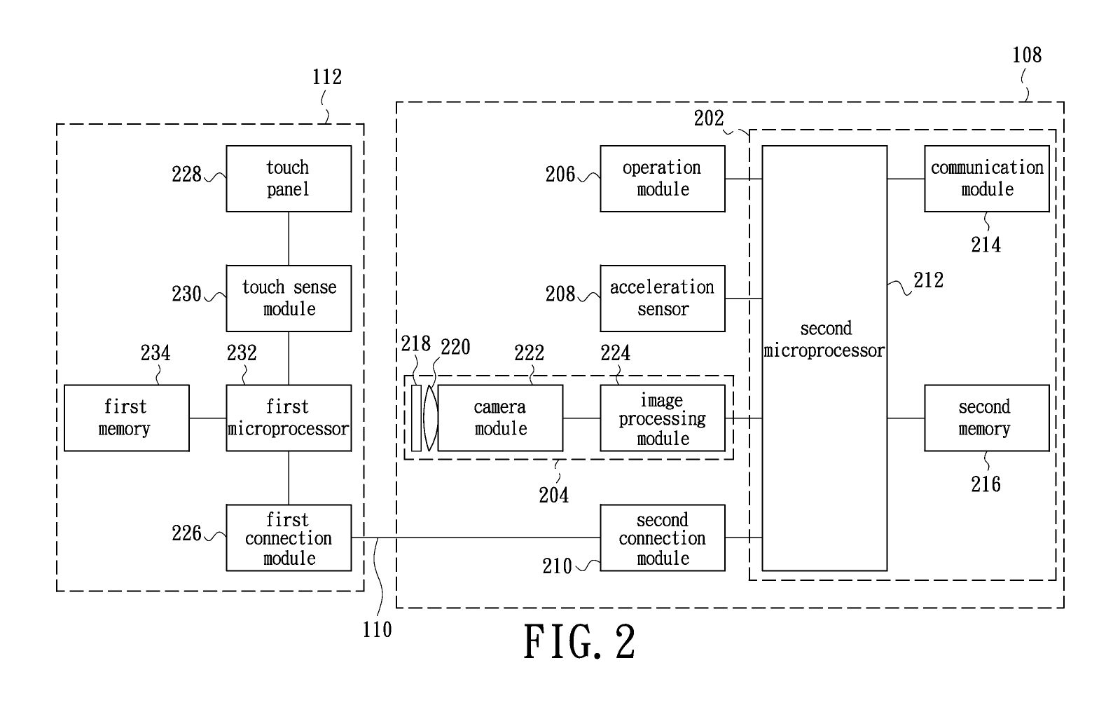

Please refer to FIG. 2, it is a schematic circuit block diagram of a two-dimensional input device and a remote controller of an embodiment of the present invention. In FIG. 2, the two-dimensional input device 112 comprises a touch panel 228, a touch sense module 230, a first microprocessor 232, a first memory 234 and a first connection module 226. The first connection module 226 is transmitted with the remote controller 108 by physical cable communication method. Wherein, the touch panel 228 is equal to the touch panel 114 on FIG. 1. Wherein, one of ordinary skill in the art should know that the touch panel 114 can be a panel of resistive, capacitance, optical and surface acoustic wave. The present invention, however, is not limited thereto.

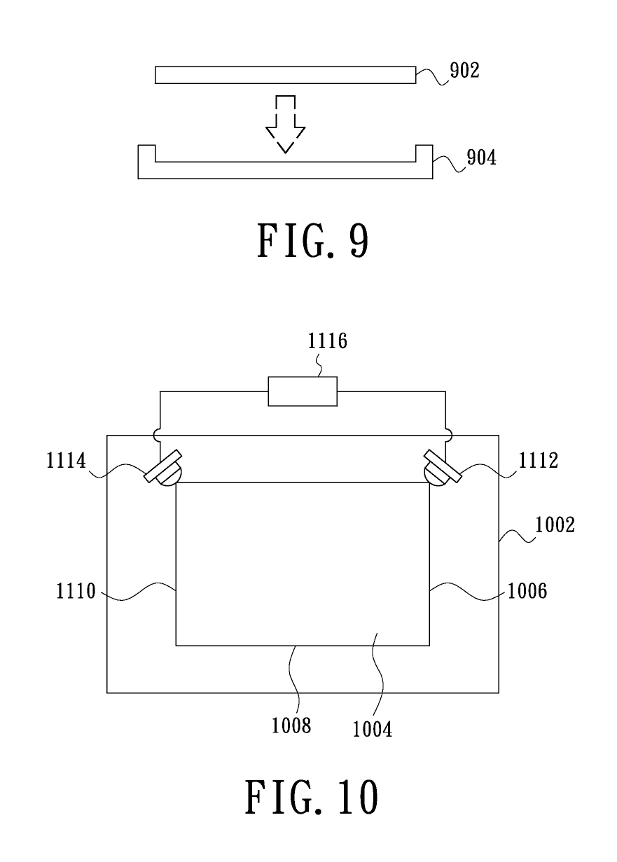

A plugboard (not shown and described in description of FIG. 9 below) has a pattern corresponding to the game program and is disposed above the touch panel 228 so that user can control or interact with the game program through touching the pattern. The pattern can be printed on a top surface of the plugboard and material of the plugboard can be produced by glass, plastics and rubber which can be transmissible or lightproof. Wherein, the pattern can be a pattern of a piano keyboard, a calculating machine, a drawing board or a map of a game. The present invention, however, is not limited thereto.

The touch panel 228 can be contact with the plugboard when being touched or before being touched.

The touch sense module 230 is coupled to the touch panel 228. When the touch panel 228 is touched, the touch sense module 230 generates a sense signal and outputs the sense signal to the first microprocessor 232.

The first microprocessor 232 receives the sense signal and performs a coordinate operation with the sense signal according to the pattern which is fined in the first memory 234 to obtain a two-dimensional coordinate data. Then, the first microprocessor 232 outputs the two-dimensional coordinate data to the first connection module 226. In this design, the two-dimensional coordinate data is used to perform a function instruction data or a present position coordinate data.

In another way of the present invention, the first microprocessor 232 performs the coordinate operation with the sense signal according to a coordinate design of the touch panel 228 to obtain the two-dimensional coordinate data after the first microprocessor 232 receives the sense signal. Then, the first microprocessor 232 outputs the two-dimensional coordinate data to the first connection module 226. In this design, the game console 102 in FIG. 1 computes a data corresponding to a frame of the game program with the two-dimensional coordinate data after the game console 102 receives the two-dimensional coordinate data and performs the data.

The first connection module 226 is coupled to the first microprocessor 232 for receiving the two-dimensional coordinate data and transmitting the two-dimensional coordinate data to the remote controller 108 by the physical cable 110.

Please refer to FIG. 2 continuously, the remote controller 108 comprises a core circuit 202, an optical image processing circuit 204, an operation module 206, an acceleration sensor 208 and a second connection module 210. Wherein, the second connection module 210 is connected to the first connection module 226 of the two-dimensional input device 112 for receiving the two-dimensional coordinate data.

The operation module 206 generates an operation instruction according to operation of user and outputs the operation instruction to the core circuit 202. The operation module 206 comprises operation keys 108a, 108b, 108c, 108d, 108e, 108f, 108g and 108h of FIG. 1.

The acceleration sensor 208 generates an acceleration data according to motion of the remote controller 108 and outputs the acceleration data to the core circuit 202. Wherein, the acceleration sensor 208 is a sensor which is used to detect acceleration or deceleration of three-axis of the remote controller 108.

The optical image processing circuit 204 captures light emitted by the illuminant emitting module 106 of FIG. 1 for obtaining a motion data of the remote controller 108 and outputting the motion data to the core circuit 202. The optical image processing circuit 204 comprises an infrared ray filter 218, a lens 220, a camera module 222 and an image processing module 224. Wherein, the infrared ray filter 218 filters an outside light and only lets the infrared ray to pass when the outside light (comprising light emitted by the illuminant emitting module 106 of FIG. 1) surrounding the infrared ray filter 218 pass the infrared ray filter 218. The lens 220 is located behind the infrared ray filter 218 for collecting the infrared ray passing the infrared ray filter 218 and outputting the infrared ray to the camera module 222.

In the embodiment, the camera module 222 is located behind the lens 220 for capturing the infrared ray transmitted from the lens 220 to obtain an image. Then, the camera module 222 outputs the image to the image processing module 224. The image processing module 224 is coupled to the camera module 222 and the core circuit 202 for recognizing a point having high luminance of the image and performing a motion operation with the point to obtain a motion data and output the motion data to the core circuit 202.

The core circuit 202 comprises a second microprocessor 212, a communication module 214 and a second memory 216. Wherein, the second microprocessor 212 is coupled to the second connection module 210, the image processing module 224, the operation module 206, the acceleration sensor 208, the communication module 214 and the second memory 216.

The second microprocessor 212 receives the two-dimensional coordinate data, the operation instruction, the acceleration data and the motion data respectively and determines position of the remote controller 108 according to the acceleration data and the motion data. Besides, the second microprocessor 212 transmits the determined present position data of the remote controller 108, the two-dimensional coordinate data and the operation instruction to the communication module 214.

The communication module 214 can communicate with the game console 102 of FIG. 1 by wire or wireless. If communicating by wire, the communication module 214 receives the determined present position data of the remote controller 108, the two-dimensional coordinate data and the operation instruction and transmits the determined present position data of the remote controller 108, the two-dimensional coordinate data and the operation instruction to the game console 102 by a physical cable (not shown) for performing. Reversely, if communicating by wireless, the communication module 214 receives the determined present position data of the remote controller 108, the two-dimensional coordinate data and the operation instruction and transmits the determined present position data of the remote controller 108, the two-dimensional coordinate data and the operation instruction to the game console 102 through antenna (not shown) after wireless signal transference.

Wherein, one of ordinary skill in the art should know that the communication method between the remote controller 108 and the game console 102 of FIG. 1 can be Bluetooth or RF (radio frequency). The present invention, however, is not limited thereto.

Wherein, the second memory 216 can store the determined present position data of the remote controller 108, the two-dimensional coordinate data and the operation instruction temporarily.

Therefore, when user of the control device 100b inputs data (i.e. the above touch panel 228 is touched) on the two-dimensional input device 112, the touch sense module 230 generates a sense signal according to touch and outputs the sense signal to the first microprocessor 232. The first microprocessor 232 receives the sense signal for performing a coordinate operation with the sense signal to obtain the two-dimensional coordinate data. Then, the first microprocessor 232 outputs the two-dimensional coordinate data to the second connection module 210 of the remote controller 108 through the first connection module 226. Secondly, the second microprocessor 212 receives the two-dimensional coordinate data and transmits the two-dimensional coordinate data to the communication module 214 after processing. The communication module 214 transmits data inputted by user to the game console 102.

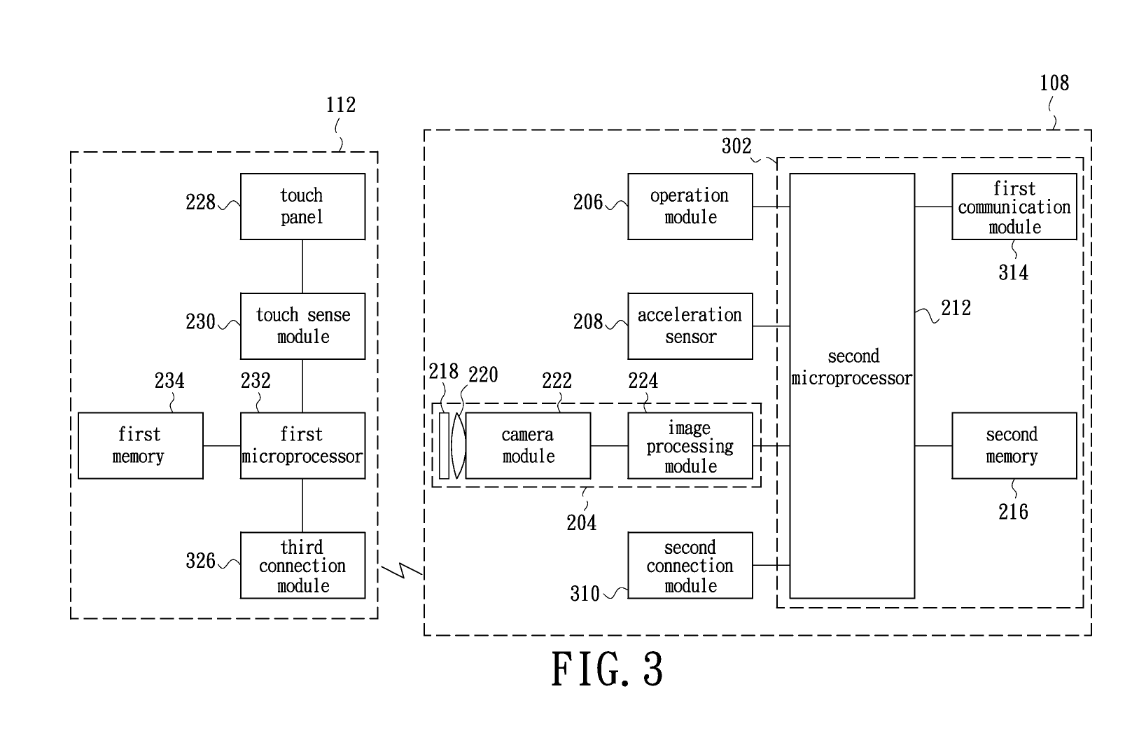

Please refer to FIG. 3, it is a schematic circuit block diagram of a two-dimensional input device and a remote controller of another embodiment of the present invention. In this embodiment, the same elements in FIG. 2's are not described here for easily describing. The different between FIG. 2 and FIG. 3 is that the two-dimensional input device 112 communicates with the remote controller 108 by wireless communication method. Therefore, a third communication module 326 is disposed in the two-dimensional input device 112 and a second communication module 310 is disposed in the remote controller 108.

As description of the two-dimensional input device 112 above, the first microprocessor 232 outputs the two-dimensional coordinate data to the third communication module 326. The third communication module 326 outputs the two-dimensional coordinate data to the second communication module 310 through the antenna (not shown) after transferring the two-dimensional coordinate data into a wireless signal. The second communication module 310 transfers the two-dimensional coordinate data into a signal which can be operated by the second microprocessor 212 and outputs the signal to the second microprocessor 212 after receiving the wireless signal with the two-dimensional coordinate data through the antenna (not shown).

In the embodiment of the present invention, the wireless communication method between the second communication module 310 and the third communication module 326 can be Bluetooth or RF (radio frequency). The present invention, however, is not limited thereto.

In this embodiment, operations of the first communication module 314 of FIG. 3 and the communication module 214 of FIG. 2 are the same and no more description here.

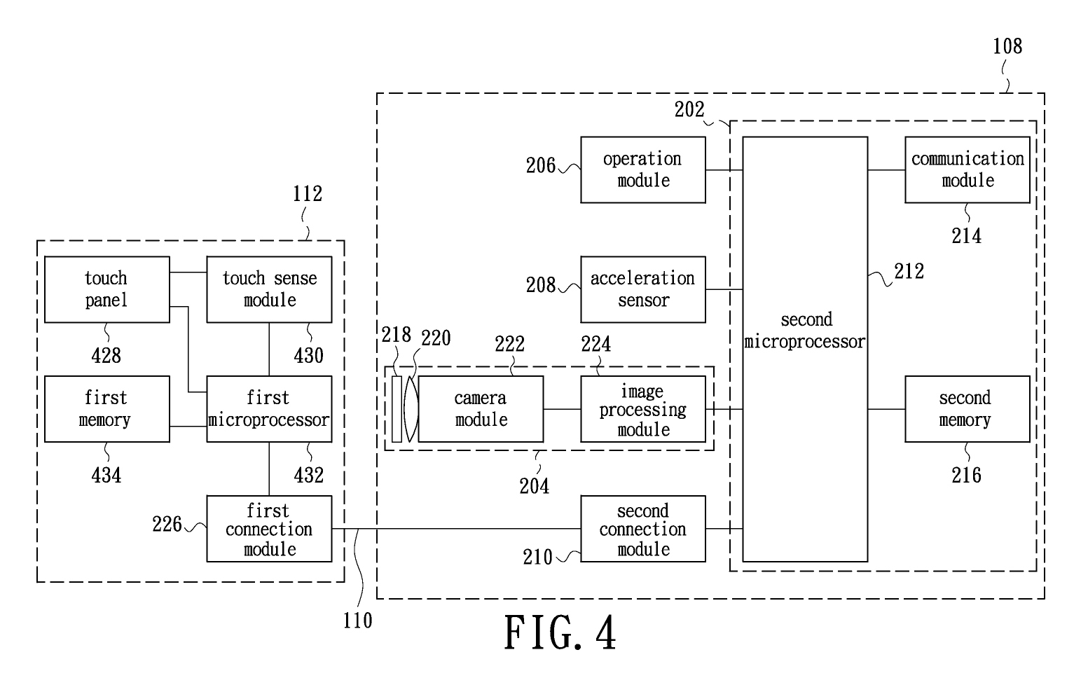

Please refer to FIG. 4, it is a schematic circuit block diagram of a two-dimensional input device and a remote controller of another embodiment of the present invention. In the present invention, operations of the remote controller 108 in FIG. 4 and operations of the remote controller 108 in FIG. 2 are the same and no more description here.

In FIG. 4, the two-dimensional input device 112 comprises a touch panel 428, a touch sense module 430, a first microprocessor 432, a first memory 434 and a first connection module 426. The first connection module 426 is transmitted with the remote controller 108 by physical cable communication method. Wherein, the touch panel 228 is equal to the touch panel 114 on FIG. 1.

The touch panel 428 is coupled to the first microprocessor 432 and controlled by user for displaying a pattern corresponding to the game program. In other words, the touch panel 428 displays a menu of the game program for providing selection to user when the two-dimensional input device 112 is enabled. The touch panel 428 also displays a corresponsive game program pattern stored in the first memory 434. Besides, after the game console 102 of FIG. 1 performs the game program, the game console 102 outputs a display pattern signal to the two-dimensional input device 112 through the remote controller 108. Then, the first microprocessor 432 of the two-dimensional input device 112 finds a corresponsive pattern of the first memory 434 according to the display pattern signal for displaying the corresponsive pattern on the touch panel 428. One of ordinary skill in the art should know that the operation method of displaying pattern of the touch panel 428 can have other methods. The present invention, however, is not limited thereto.

The touch sense module 430 is coupled to the touch panel 428. The touch sense module 430 generates a sense signal when being touched and outputs the sense signal to the first microprocessor 432.

The first microprocessor 432 is coupled to the touch sense module 430 and the first memory 434. When the first microprocessor 432 receives the sense signal, the first microprocessor 432 searches a corresponsive pattern of the first memory 434 for performing a coordinate operation with the sense signal according to the pattern to obtain a two-dimensional coordinate data. Then, the first microprocessor 432 outputs the two-dimensional coordinate data to the first connection module 226. In this design, the two-dimensional coordinate data is used to perform a function instruction data or present position coordinate data.

In another way of the present invention, the first microprocessor 432 performs the coordinate operation with the sense signal according to a coordinate design of the touch panel 428 to obtain the two-dimensional coordinate data. Then, the first microprocessor 432 outputs the two-dimensional coordinate data to the first connection module 426. In this design, the game console 102 in FIG. 1 computes a data corresponding to a frame of the game program with the two-dimensional coordinate data and performs the data after receiving the two-dimensional coordinate data.

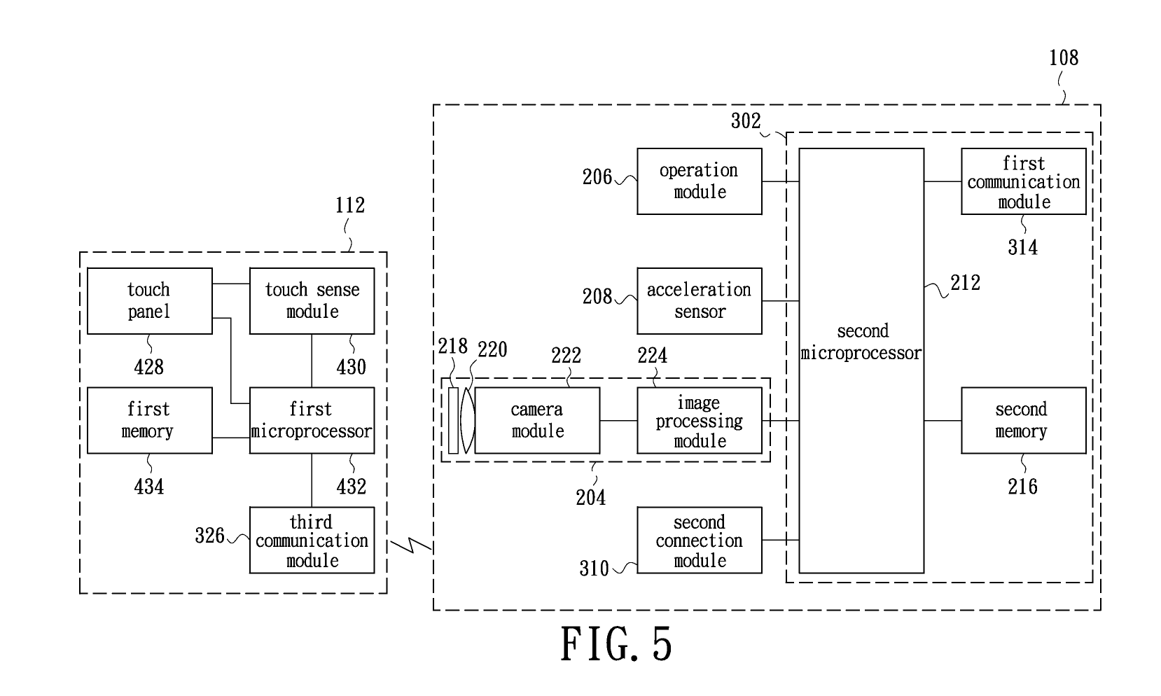

Please refer to FIG. 5, it is a schematic circuit block diagram of a two-dimensional input device and a remote controller of another embodiment of the present invention. In the present invention, the same elements in FIG. 4's are not described here for easily describing. The different between FIG. 4 and FIG. 5 is that the two-dimensional input device 112 communicates with the remote controller 108 by wireless communication method. Therefore, a third communication module 326 is disposed in the two-dimensional input device 112 and a second communication module 310 is disposed in the remote controller 108.

As description of the two-dimensional input device 112 above, the first microprocessor 432 outputs the two-dimensional coordinate data to the third communication module 326. The third communication module 326 outputs the two-dimensional coordinate data to the second communication module 310 through the antenna (not shown) after transferring it into a wireless signal. The second communication module 310 transfers the two-dimensional coordinate data into a signal which can be operated by the second microprocessor 212 and outputs the signal to the second microprocessor 212 after receiving the wireless signal with the two-dimensional coordinate data through the antenna (not shown).

In the embodiment of the present invention, the wireless communication method between the second communication module 310 and the third communication module 326 can be Bluetooth or RF (radio frequency). The present invention, however, is not limited thereto.

In this embodiment, operations of the first communication module 314 of FIG. 5 and the communication module 214 of FIG. 5 are the same and no more description here.

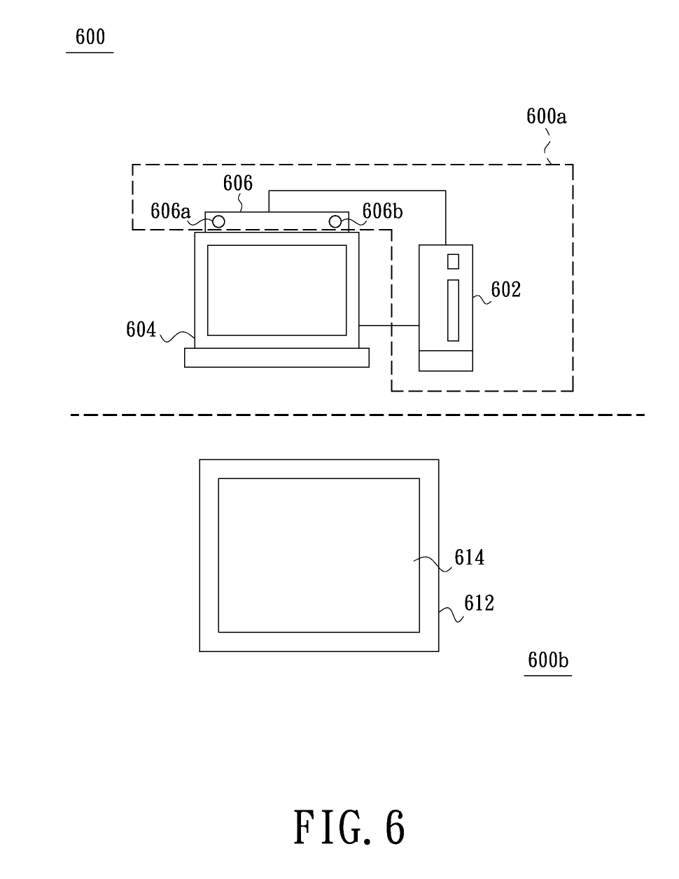

Please refer to FIG. 6, it is a schematic diagram of an interactive game system of another embodiment of the present invention. In FIG. 6, the interactive game system 600 comprises a main game device 600a, a control device 600b and a display 604. Wherein, the main game device 600a comprises a game console 602 and an illuminant emitting module 606, and the control device 600b comprises a two-dimensional input device 612. Wherein, the two-dimensional input device 612 comprises a touch panel 614.

In this embodiment, the game console 602 and the game console 602 of FIG. 1 are the same and no more description here. Besides, the display 604 and the illuminant emitting module 606 and the display 104 and the illuminant emitting module 106 of FIG. 1 are respectively the same and no more description here.

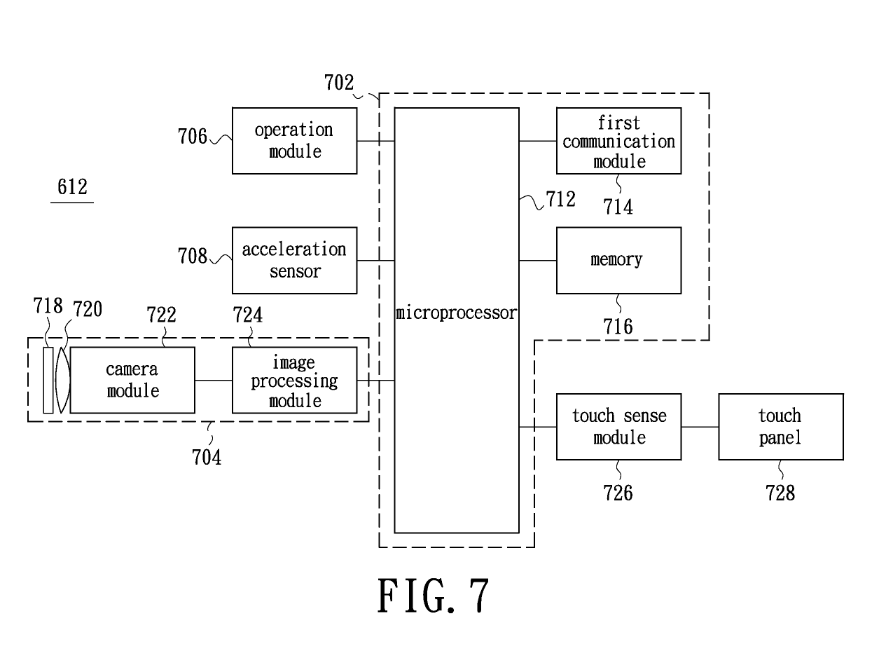

Please refer to FIG. 7, it is a schematic circuit block diagram of a two-dimensional input device and a remote controller of FIG. 6 of the present invention. In FIG. 7, the two-dimensional input device 612 comprises a core circuit 702, an optical image processing circuit 704, an operation module 706, an acceleration sensor 708, a touch panel 728 and a touch sense module 726. Besides, the core circuit 702 comprises a microprocessor 712, a communication module 714 and a memory 716. Wherein, the panel 728 is equal to the touch panel 614 of FIG. 6. Wherein, one of ordinary skill in the art should know that the touch panel 614 can be a panel of resistive, capacitance, optical and surface acoustic wave. The present invention, however, is not limited thereto.

A plugboard (not shown and described in description of FIG. 9 below) has a pattern corresponding to the game program and is disposed above the touch panel 728 so that user can control or interact with the game program through touching the pattern. The pattern can be printed on a top surface of the plugboard and material of the plugboard can be produced by glass, plastics and rubber which can be transmissible or lightproof. Wherein, the pattern can be a pattern of a piano keyboard, a calculating machine, a drawing board or a map of game. The present invention, however, is not limited thereto.

The touch panel 728 can be contact with the plugboard when being touched or before being touched.

The touch sense module 726 is coupled to the touch panel 728. When the touch panel 728 is touched, the touch sense module 726 generates a sense signal and outputs the sense signal to the microprocessor 712.

The microprocessor 712 receives the sense signal and performs a coordinate operation with the sense signal according to the pattern which is fined in the first memory 716 to obtain a two-dimensional coordinate data. Then, the microprocessor 712 outputs the two-dimensional coordinate data to the communication module 714. In this design, the two-dimensional coordinate data is used to perform a function instruction data or present position coordinate data.

In another way of the present invention, the microprocessor 712 performs the coordinate operation with the sense signal according to a coordinate design of the touch panel 728 to obtain the two-dimensional coordinate data after the microprocessor 712 receives the sense signal. Then, the microprocessor 712 outputs the two-dimensional coordinate data to the communication module 714. In this design, the game console 602 in FIG. 6 computes a data corresponding to a frame of the game program with the two-dimensional coordinate data and performs the data after receiving the two-dimensional coordinate data.

In the present embodiment, operation keys 108a, 108b, 108c, 108d, 108e, 108f, 108g and 108h of FIG. 1 are disposed on the operation module 706 of the two-dimensional input device 612 for generating an operation instruction according to touch of user and outputting the operation instruction to the microprocessor 712.

Besides, in the present embodiment, the operation module 706 can be abbreviated and the touch panel 728 is disposed patterns similar the operation keys of FIG. 1 for providing touch of user. Therefore, hardware operation keys are not needed to be disposed and only a pattern printed with operation keys is needed to be disposed on the touch panel 728 so that the pattern is touch control.

The acceleration sensor 708 generates an acceleration data according to motion of the two-dimensional input device 612 and outputs the acceleration data to the microprocessor 712. Wherein, the acceleration sensor 708 is a sensor which used to detect acceleration or deceleration of three-axis of the two-dimensional input device 612.

The optical image processing circuit 704 captures light emitted by the illuminant emitting module 606 of FIG. 6 for obtaining a motion data of the two-dimensional input device 612 and outputting the motion data to the microprocessor 712. The optical image processing circuit 704 comprises an infrared ray filter 718, a lens 720, a camera module 722 and an image processing module 724. Wherein, the infrared ray filter 718 filters an outside light and only lets the infrared ray to pass when the outside light (comprising light emitted by the illuminant emitting module 606 of FIG. 6) surrounding the infrared ray filter 718 pass the infrared ray filter 718. The lens 720 is located behind the infrared ray filter 718 for collecting the infrared ray passing the infrared ray filter 718 and outputting the infrared ray to the camera module 722.

In the embodiment, the camera module 722 is located behind the lens 720 for capturing the infrared ray to obtain an image. Then, the camera module 722 outputs the image to the image processing module 724. The image processing module 724 is coupled to the camera module 722 and the microprocessor 712 for recognizing a point having high luminance of the image and performing a motion operation with the point to obtain a motion data and output the motion data to the microprocessor 712.

In the present invention, the microprocessor 712 is coupled to the image processing module 724, the operation module 706, the acceleration sensor 708, the communication module 714 and the memory 716.

The microprocessor 712 receives the sense signal, the operation instruction, the acceleration data and the motion data respectively and determines position of the two-dimensional input device 612 according to the acceleration data and the motion data. Besides, the microprocessor 712 transmits the determined present position data of the two-dimensional input device 612, the two-dimensional coordinate data and the operation instruction to the communication module 714.

The communication module 714 can communicate with the game console 602 of FIG. 6 by wire or wireless. If communicating by wire, the communication module 714 receives the determined present position data of the two-dimensional input device 612, the two-dimensional coordinate data and the operation instruction and transmits the determined present position data of the two-dimensional input device 612, the two-dimensional coordinate data and the operation instruction to the game console 602 by a physical cable (not shown) for performing. Reversely, if communicating by wireless, the communication module 714 receives the determined present position data of the two-dimensional input device 612, the two-dimensional coordinate data and the operation instruction and transmits the determined present position data of the two-dimensional input device 612, the two-dimensional coordinate data and the operation instruction to the game console 602 through antenna (not shown) after wireless signal transference.

Wherein, one of ordinary skill in the art should know that the communication method between the two-dimensional input device 612 and the game console 602 of FIG. 6 can be Bluetooth or RF (radio frequency). The present invention, however, is not limited thereto.

Wherein, the memory 716 can store the determined present position data of the two-dimensional input device 612, the two-dimensional coordinate data and the operation instruction temporarily.

Therefore, the touch sense module 730 generates a sense signal and outputs the sense signal to the microprocessor 712 when user of the control device 600b inputs data on the two-dimensional input device 612 (i.e. the above touch panel 728 is touched). The microprocessor 712 receives the sense signal for performing a coordinate operation to obtain the two-dimensional coordinate data. Then, the microprocessor 712 outputs the two-dimensional coordinate data to the communication module 714 after processing. Secondly, the microprocessor 712 receives the two-dimensional coordinate data and transmits the two-dimensional coordinate data to the communication module 714 after processing. The communication module 714 transmits data inputted by user to the game console 602.

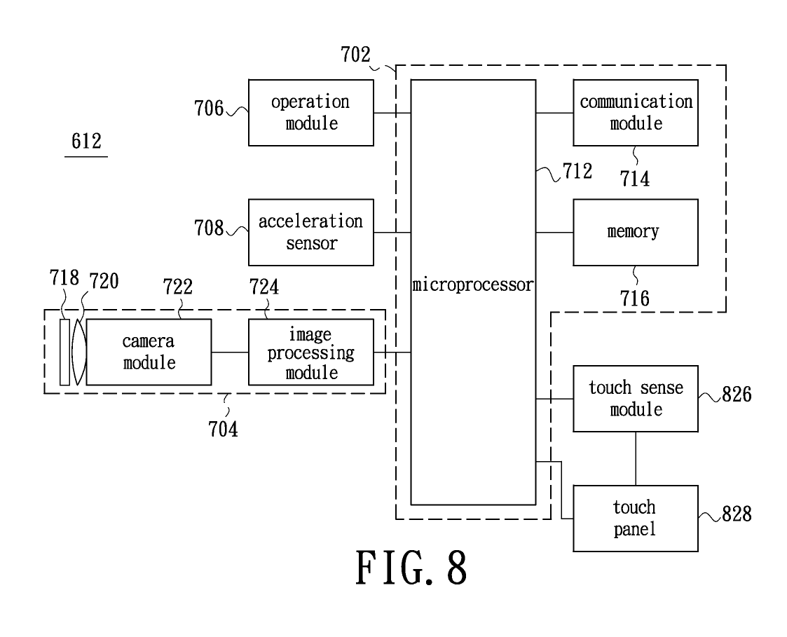

Please refer to FIG. 8, it is a schematic circuit block diagram of another two-dimensional input device of FIG. 6 of the present invention. In this embodiment, the same elements in FIG. 7's are not described here for easily describing. The different between FIG. 7 and FIG. 8 is that the two-dimensional input device 612 of FIG. 7 needs to be collocated with the plugboard and the two-dimensional input device 612 of FIG. 8 can self-display the pattern of the game program on the touch panel 828.

The touch panel 828 is coupled to the microprocessor 712 and controlled by user for displaying a pattern corresponding to the game program. In other words, the touch panel 828 displays a menu of the game program for providing selection to user when the two-dimensional input device 612 is enabled. The touch panel 828 also displays a corresponsive game program pattern stored in the memory 716. Besides, after the game console 602 of FIG. 6 performs the game program, the game console 602 outputs a display pattern signal to the two-dimensional input device 612. Then, the microprocessor 712 of the two-dimensional input device 612 finds a corresponsive pattern of the memory 716 according to the display pattern signal for displaying the corresponsive pattern on the touch panel 828. One of ordinary skill in the art should know that the operation method of displaying pattern of the touch panel 828 can have other methods. The present invention, however, is not limited thereto.

The touch sense module 826 is coupled to the touch panel 828. The touch sense module 826 generates a sense signal and outputs the sense signal to the microprocessor 712 when being touched.

The microprocessor 712 is coupled to the touch sense module 826 and the memory 716. When the microprocessor 712 receives the sense signal, the microprocessor 712 searches a corresponsive pattern of the memory 716 for performing a coordinate operation with the sense signal according to the pattern to obtain a two-dimensional coordinate data. Then, the microprocessor 712 outputs the two-dimensional coordinate data to the communication module 714. In this design, the two-dimensional coordinate data is used to perform a function instruction data or present position coordinate data.

In another way of the present invention, the microprocessor 712 receives the sense signal and performs the coordinate operation with the sense signal according to a coordinate design of the touch panel 828 to obtain the two-dimensional coordinate data. Then, the microprocessor 712 outputs the two-dimensional coordinate data to the communication module 714. In this design, the game console 602 in FIG. 6 computes a data corresponding to a frame of the game program with the two-dimensional coordinate data after receiving the two-dimensional coordinate data and performs the data.

Besides, in the present embodiment, the operation module 706 can be abbreviated and the touch panel 828 is disposed patterns similar the operation keys of FIG. 1 for providing touch of user. Therefore, hardware operation keys are not needed to be disposed and only a pattern is needed to be stored in memory 716 so that the pattern is touch control.

In a prefer embodiment of the present invention, the display will display corresponsive piano keyboard if the plugboard or the pattern displayed on the touch panel is a piano keyboard. Therefore, on the display, one of identical horizontal piano keyboards corresponding to the touched piano keyboard of the plugboard or the pattern displayed on the touch panel is lower than other adjacent piano keyboards to indicate the piano keyboard is pressed by the user if the user touches one of piano keyboards of the plugboard or the pattern displayed on the touch panel. If the plugboard or the pattern displayed on the touch panel is a pattern of the game program, user can use the remote controller of right hand (left hand) to control action of person of the game program and the two-dimensional input device of left hand (right hand) to control motion of person of the game program. For example, if touch of the user on the two-dimensional input device is from left to right, the game console performs a motion according to the received two-dimensional coordinate data. Thus, position of the person displayed on the display will move to right from the present position.

Please refer to FIG. 9, it is a schematic of disposed position of the game plugboard and the two-dimensional input device of an embodiment of the present invention. In the present invention, the plugboard 902 and the two-dimensional input device 904 are suitable for the two-dimensional input device of FIG. 2, FIG. 3 and FIG. 7 described above. In FIG. 9, the two-dimensional input device 904 is similar to the label 112 of FIG. 1 and the label 612 of FIG. 6 and it is presented as a concave shape. But shape of the two-dimensional input device 904 should be defined by actual design need. The present invention, however, is not limited thereto.

In the present invention, the plugboard 902 is disposed into the concave slut of the two-dimensional input device 904 from top to bottom (perpendicular) and the plugboard 902 is touched with an inter-surface of the two-dimensional input device 904 for fixing the plugboard 902. Besides, the plugboard 902 can be disposed into the concave slut of the two-dimensional input device 904 in horizontal direction for touching with the inter-surface of the two-dimensional input device 904. One of ordinary skill in the art should know that a locking structure can be added on the two-dimensional input device 904 for fixing the plugboard 902 so that the plugboard 902 can be fixed above the two-dimensional input device 904.

In a prefer embodiment of the present invention, the touch panel 114 and 614 can be multitouch or single touch for user at the same time. In the other words, user can use one finger or a plurality of fingers to control the two-dimensional input devices 112 and 612. The two-dimensional input devices 112 and 612 which cab be composed by a panel of resistive, capacitance, optical and surface acoustic wave are described below.

Please refer to FIG. 10, it is a schematic diagram of the two-dimensional input device applying with optical sense of an embodiment of the present invention. The two-dimensional input device 1002 comprises a touch control area 1004, a plurality of photosensors 1114, 1112 and a processing circuit 1116. The photosensors 1114 and 1112 are coupled to the processing circuit 1116 respectively. Wherein, a shape of the touch control area 1004 is a rectangle. Three sides of the touch control area 1004 are disposed with the retro-reflectors 1006, 1008 and 1110. A range sensed by the photosensor 1114 is a reflection area formed by the retro-reflectors 1006 and 1008 and a range sensed by the photosensor 1112 is a reflection area formed by the retro-reflectors 1008 and 1110. Therefore, when the touch control area 1004 is touched, the photosensors 1114 and 1112 transmit images to the processing circuit 1116 which is similar to the first microprocessor 232 of FIG. 2 and the microprocessor 712 of FIG. 7 for processing and obtaining a coordinate position of the touch point with a triangle computing method. Wherein, for example, the triangle computing method for obtaining the coordinate position of the touch point can be a computing method disclosed in U.S. Pat. Nos. 4,782,328, 4,504,557 and 6,803,906.

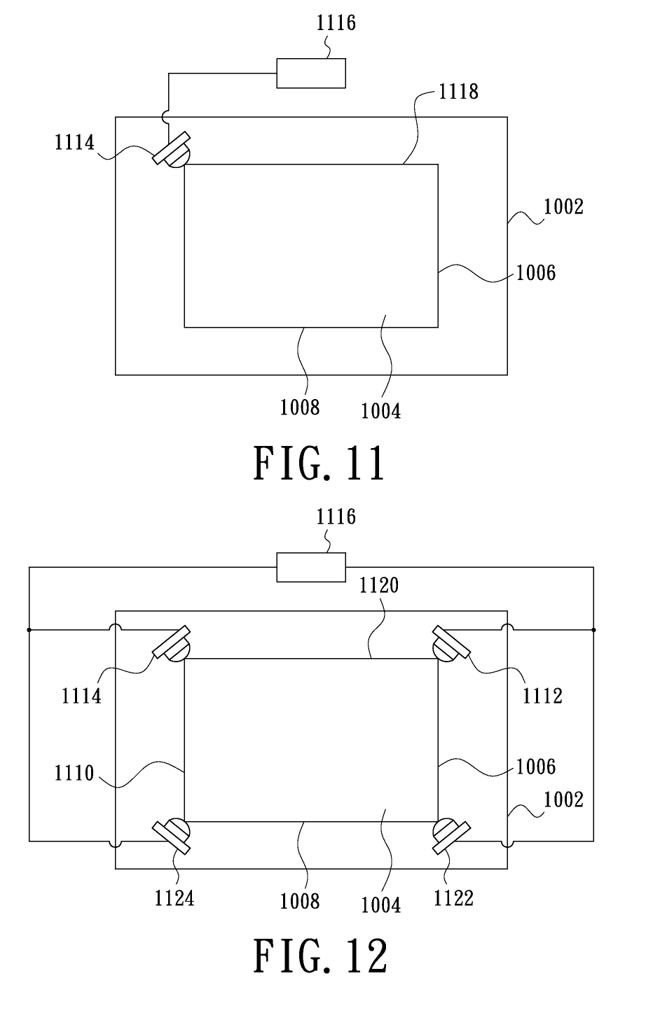

Now, please refer to FIG. 11, it is a schematic diagram of the two-dimensional input device applying with optical sense of another embodiment of the present invention. The two-dimensional input device 1002 comprises a touch control area 1004, a photosensor 1114 and a processing circuit 1116. Wherein, a shape of the touch control area 1004 is a rectangle. Three sides of the touch control area 1004 are disposed with the retro-reflectors 1006, 1008 and 1118 and the retro-reflector 1008 can be a plane mirror. The present invention, however, is not limited thereto.

In FIG. 11, when the touch control area 1004 is touched, the photosensors 1114 and 1112 transmit images to the processing circuit 1116 which is similar to the first microprocessor 232 of FIG. 2 and the microprocessor 712 of FIG. 7 for processing and obtaining a coordinate position of the touch point. The computing method of FIG. 11 can be the computing method disclosed in R.O.C. Application Number 098100969 filed on Jan. 12, 2009.

Please refer FIG. 12 hereinbelow, it is a schematic diagram of the two-dimensional input device applying with optical sense of other embodiment of the present invention. The two-dimensional input device 1002 comprises a touch control area 1004, a plurality of photosensors 1112, 1114, 1122, 1124 and a processing circuit 1116. The photosensors 1112, 1114, 1122, and 1124 are coupled to the processing circuit 1116 respectively. Wherein, a shape of the touch control area 1004 is a rectangle. Four sides of the touch control area 1004 are disposed with the retro-reflectors 1006, 1008, 1110 and 1120. In FIG. 12, when the touch control area 1004 is touched, the photosensors 1114 and 1112 transmit images to the processing circuit 1116 which is similar to the first microprocessor 232 of FIG. 2 and the microprocessor 712 of FIG. 7 for processing and obtaining a coordinate position of the touch point. The computing method of FIG. 12 can be the computing method disclosed in R.O.C. Application Number 097143217 filed on Nov. 7, 2008.

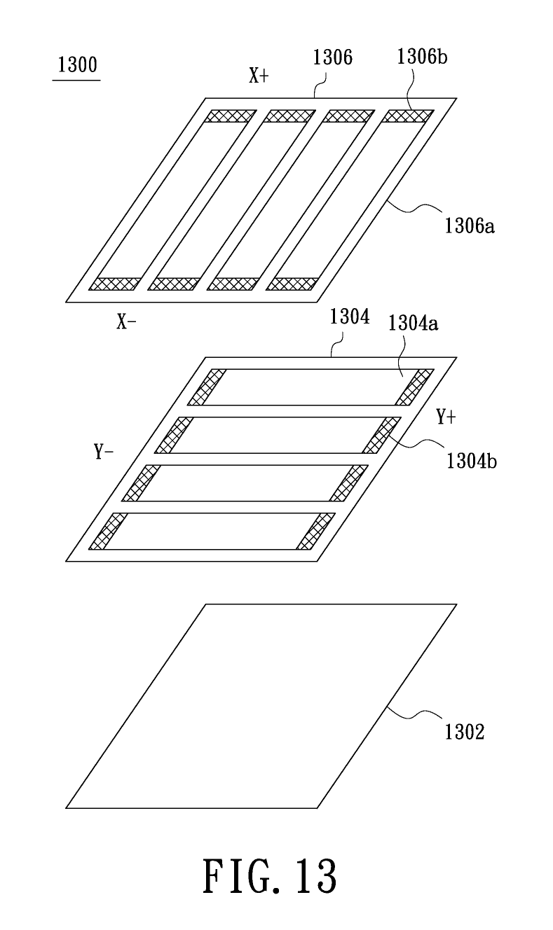

Please refer FIG. 13, it is a schematic diagram of the two-dimensional input device applying with resistive sense of other embodiment of the present invention. The touch panel 1300 of the two-dimensional input device comprises an insulation thin film 1302, a substratum through thin film 1304 and a superstratum through thin film 1306, wherein the substratum through thin film 1304 is disposed between the insulation thin film 1302 and the superstratum through thin film 1306. A plurality of Y axis through resistor detect patterns 1304a are disposed on a top surface of the substratum through thin film 1304, and a plurality of X axis through resistor detect patterns 1306a are disposed on an under surface of the superstratum through thin film 1306. Wherein, lines of each Y axis through resistor detect pattern 1304a are arranged parallel, and lines of each X axis through resistor detect pattern 1306a are also arranged parallel. Therefore, lines of each Y axis through resistor detect pattern 1304a and lines of each X axis through resistor detect pattern 1306a are formed as perpendicular rows and columns. Besides, the Y axis electrodes 1304b are disposed at two terminals of lines of the Y axis through resistor detect pattern 1304a, and the X axis electrodes 1306b are disposed at two terminals of lines of the X axis through resistor detect pattern 1306a. After the two-dimensional input device is enabled, the Y axis electrodes 1304b and the X axis electrodes 1306b are supplied with voltages continuously and changes of the voltages are detected periodically.

In FIG. 13, when the superstratum through thin film 1306 is touched, i.e. the touch sense module 230 of FIG. 2 receives the sense signal and transmits the sense signal to the first microprocessor 232 of FIG. 2 for processing and obtaining a coordinate position of the touch point. The computing method of FIG. 13 can be the computing method disclosed in R.O.C. Public Number 200915165.

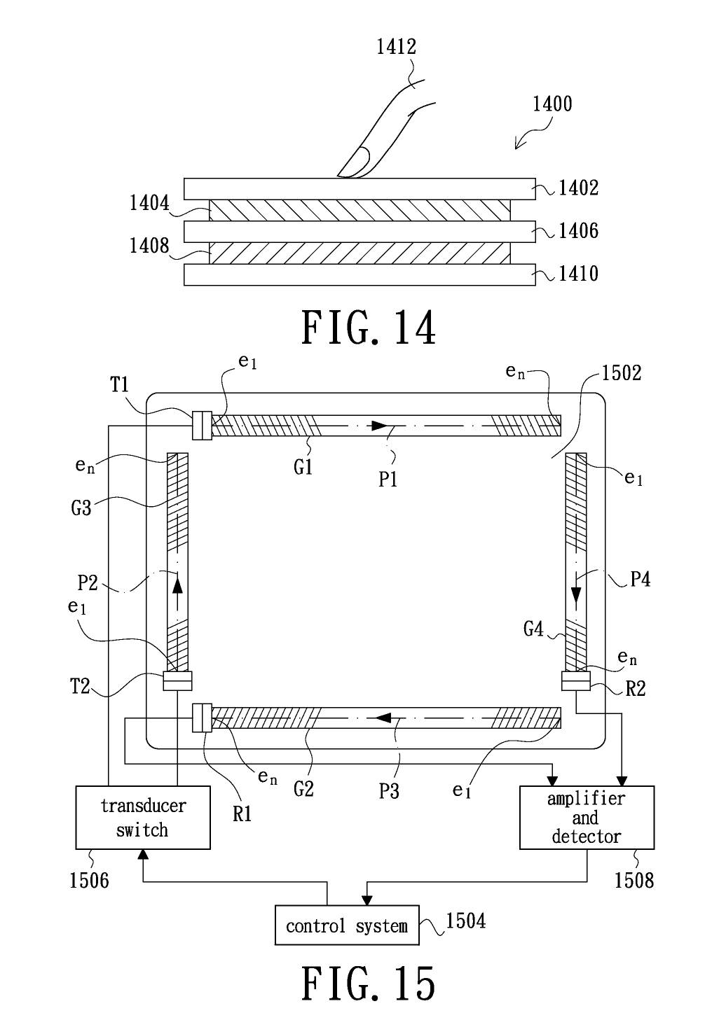

Please refer FIG. 14, it is a schematic diagram of the two-dimensional input device applying with capacitance sense of other embodiment of the present invention. The touch panel 1400 of the two-dimensional input device from top to bottom comprises a panel 1402, a Y axis sense layer 1404, an isolation layer 1406, an X axis sense layer 1408 and a bedplate 1410. When the finger 1412 touches the panel 1402, a sense quantity (capacitance) of the touched point will be changed so that the touch sense module 230 (as shown in FIG. 2) connected to the touch control plate 1400 receives a sense signal of capacitance change for transmitting the sense signal to the first microprocessor 232 of FIG. 2 to obtain a coordinate position of the touch point after processing (the capacitance is transferred into sense quantity, for example, it is represented that the touch control plate 1400 is touched when the sense quantity is larger than a predetermined threshold value; otherwise, it is represented that touch of the touch control plate 1400 is finish or there is no object existing on the touch control plate 1400). The computing method of FIG. 14 can be the computing method disclosed in R.O.C. Patent Number I269997.

Please refer FIG. 15, it is a schematic diagram of the two-dimensional input device applying with surface acoustic wave sense of other embodiment of the present invention. The two-dimensional input device 1500 comprises a base plate 1502, a control system 1504, a transducer switch 1506 and an amplifier and detector 1508, wherein the transducer switch 1506 and the amplifier and detector 1508 are coupled to the control system 1504. The control system 1504 can be the touch sense module 230 or the first microprocessor 232 of FIG. 2.

A couple of the transmitter transducers T1, T2 and a couple of the receiver transducers R1, R2 are disposed on the base plate 1502 for connecting the control system 1504. Each transducer (T1, T2, R1 and R2) has reflective gratings G1, G2, G3 and G4 composed of a plurality of reflective elements (e1 to en) disposed along paths P1, P2, P3 and P4. The control system 1504 generates a transmission signal through the transducer switch 1506 for transmitting the transmission signal to the respondent transmitter transducer T1, T2 respectively so that the transmitter transducer T1, T2 can generate a surface acoustic wave for propagating along paths P1, P2. Secondly, the receiver transducers R1, R2 transfer the received surface acoustic wave energy into signals for outputting to the amplifier and detector 1508. The computing method of FIG. 11 can be the computing method disclosed in U.S. Pat. No. 4,644,100.

Accordingly, in the two-dimensional input device and the control device of the present invention, the two-dimensional input device is disposed in the control device so that user can input data interacting with the game program on the two-dimensional input device due to a specific game program's pattern can be displayed by a plugboard or itself on the two-dimensional input device. Therefore, it can provide more diversification selection of the game program to user. Besides, the two-dimensional input device can communicate with the game console alone so that operation complex can be reduced and play more game programs.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A control device suitable for communicating with a game console which performing a game program, the control device comprising:
a two-dimensional input device comprising a touch panel displaying a pattern corresponding to the game program for generating a two-dimensional coordinate data when being touched and outputting the two-dimensional coordinate data; and
a remote controller for receiving the two-dimensional coordinate data by a first communication method and outputting the two-dimensional coordinate data to the game console by a second communication method;
wherein the game console receives the two-dimensional coordinate data and performs the game program according to the two-dimensional coordinate data.

2. The control device of claim 1, wherein the two-dimensional input device further comprises:
a touch sense module coupled to the touch panel for generating a sense signal according to touch of the touch panel and outputting the sense signal;
a first memory for storing the pattern;
a first microprocessor coupled to the touch sense module and the first memory for performing a coordinate operation with the sense signal according to the pattern when receiving the sense signal to generate the two-dimensional coordinate data and output the two-dimensional coordinate data; and
a first connection module coupled to the first microprocessor for receiving the two-dimensional coordinate data and outputting the two-dimensional coordinate data to the remote controller by the first communication method, wherein the first communication method is physical cable transmission communication method;
wherein the touch panel is coupled to the touch sense module and the first microprocessor for displaying the pattern of the first memory controlled by the first microprocessor.

3. The control device of claim 1, wherein the two-dimensional input device further comprises:
a touch sense module coupled to the touch panel for generating a sense signal according to touch of the touch panel and outputting the sense signal;
a first memory for storing the pattern;
a first microprocessor coupled to the touch sense module for performing a coordinate operation with the sense signal according to the pattern when receiving the sense signal to generate the two-dimensional coordinate data and output the two-dimensional coordinate data; and
a third communication module coupled to the first microprocessor for receiving the two-dimensional coordinate data and outputting the two-dimensional coordinate data to the remote controller by the first communication method;
wherein, the touch panel is coupled to the touch sense module and the first microprocessor for displaying the pattern of the first memory controlled by the first microprocessor, and the first communication method is wireless transmission method and the third communication module transfers the two-dimensional coordinate data into a wireless signal with the two-dimensional coordinate data for outputting.

4. The control device of claim 1, wherein the game console is coupled to an illuminant emitting module and the illuminant emitting module emits light after being enabled.

5. The control device of claim 4, wherein the remote controller comprises:
an operation module for generating an operation instruction according to operation of user and outputting the operation instruction;
an acceleration sensor for generating an acceleration data according to motion of the remote controller and outputting the acceleration data;
an optical image processing circuit for capturing light emitted by the illuminant emitting module to obtain a motion data and output the motion data;
a second connection module for receiving the two-dimensional coordinate data by the first communication method and outputting the two-dimensional coordinate data, wherein the first communication method is physical cable transmission communication method; and
a core circuit, comprising:
a second microprocessor coupled to the second connection module, the optical image processing circuit, the operation module and the acceleration sensor for receiving and outputting the two-dimensional coordinate data, the operation instruction, the acceleration data and the motion data;
a communication module coupled to the second microprocessor for receiving the two-dimensional coordinate data, the operation instruction, the acceleration data and the motion data and outputting the two-dimensional coordinate data, the operation instruction, the acceleration data and the motion data to the game console by the second communication method; and
a second memory coupled to the second microprocessor for storing the two-dimensional coordinate data, the operation instruction, the acceleration data and the motion data temporarily.

6. The control device of claim 4, wherein the remote controller comprises:
an operation module for generating an operation instruction according to operation of user and outputting the operation instruction;
an acceleration sensor for generating an acceleration data according to motion of the remote controller and outputting the acceleration data;
an optical image processing circuit for capturing light emitted by the illuminant emitting module to obtain a motion data and output the motion data;
a second communication module for receiving the two-dimensional coordinate data by the first communication method and outputting the two-dimensional coordinate data, wherein the first communication method is wireless transmission method; and
a core circuit, comprising:
a second microprocessor coupled to the second communication module, the optical image processing circuit, the operation module and the acceleration sensor for receiving and outputting the two-dimensional coordinate data, the operation instruction, the acceleration data and the motion data;
a first communication module coupled to the second microprocessor for receiving the two-dimensional coordinate data, the operation instruction, the acceleration data and the motion data and outputting the two-dimensional coordinate data, the operation instruction, the acceleration data and the motion data to the game console by the second communication method; and
a second memory coupled to the second microprocessor for storing the two-dimensional coordinate data, the operation instruction, the acceleration data and the motion data temporarily.

7. The control device of claim 1, wherein the touch panel is a panel of resistive, capacitance, optical and surface acoustic wave.

8. A control device suitable for communicating with a game console which performing a game program, the control device comprising:
a game plugboard having a pattern corresponding to the game program;
a two-dimensional input device comprising a touch panel disposed under the game plugboard for generating a two-dimensional coordinate data when the pattern is touched and outputting a two-dimensional coordinate data; and
a remote controller for receiving the two-dimensional coordinate data by a first communication method and outputting the two-dimensional coordinate data to the game console by a second communication method;
wherein, the game console receives the two-dimensional coordinate data and performs the game program according to the two-dimensional coordinate data.

9. The control device of claim 8, wherein the two-dimensional input device further comprises:
a touch sense module coupled to the touch panel for generating a sense signal according to touch of the game plugboard and outputting the sense signal;
a first microprocessor coupled to the touch sense module for performing a coordinate operation to generate the two-dimensional coordinate data and output the two-dimensional coordinate data when receiving the sense signal; and
a first connection module coupled to the first microprocessor for receiving the two-dimensional coordinate data and outputting the two-dimensional coordinate data to the remote controller by the first communication method, wherein the first communication method is physical cable transmission communication method.

10. The control device of claim 8, wherein the two-dimensional input device further comprises:
a touch sense module coupled to the touch panel for generating a sense signal according to touched of the game plugboard and outputting the sense signal;
a first microprocessor coupled to the touch sense module for performing a coordinate operation with the sense signal when receiving the sense signal to generate a two-dimensional coordinate data and output the two-dimensional coordinate data; and
a third communication module coupled to the first microprocessor for receiving the two-dimensional coordinate data and outputting the two-dimensional coordinate data to the remote controller by the first communication method;
wherein the first communication method is wireless transmission method and transfers the two-dimensional coordinate data into a wireless signal with the two-dimensional coordinate data for outputting.

11. The control device of claim 8, wherein the game console is coupled to an illuminant emitting module and the illuminant emitting module emits light after being enabled.

12. The control device of claim 11, wherein the remote controller comprises:
an operation module for generating an operation instruction according to operation of user and outputting the operation instruction;
an acceleration sensor for generating an acceleration data according to motion of the remote controller and outputting the acceleration data;
an optical image processing circuit for capturing light emitted by the illuminant emitting module to obtain a motion data and output the motion data;
a second connection module for receiving the two-dimensional coordinate data by the first communication method and outputting the two-dimensional coordinate data, wherein the first communication method is physical cable transmission communication method; and
a core circuit, comprising:
a second microprocessor coupled to the second connection module, the optical image processing circuit, the operation module and the acceleration sensor for receiving and outputting the two-dimensional coordinate data, the operation instruction, the acceleration data and the motion data;
a communication module coupled to the second microprocessor for receiving the two-dimensional coordinate data, the operation instruction, the acceleration data and the motion data and outputting the two-dimensional coordinate data, the operation instruction, the acceleration data and the motion data to the game console by the second communication method; and
a second memory coupled to the second microprocessor for storing the two-dimensional coordinate data, the operation instruction, the acceleration data and the motion data temporarily.

13. The control device of claim 11, the remote controller comprises;
an operation module for generating an operation instruction according to operation of user and outputting the operation instruction;
an acceleration sensor for generating an acceleration data according to motion of the remote controller and outputting the acceleration data;
an optical image processing circuit for capturing light emitted by the illuminant emitting module to obtain a motion data and output the motion data;
a second communication module for receiving the two-dimensional coordinate data by the first communication method and outputting the two-dimensional coordinate data, wherein the first communication method is wireless transmission method; and
a core circuit, comprising:
a second microprocessor coupled to the second communication module, the optical image processing circuit, the operation module and the acceleration sensor for receiving and outputting the two-dimensional coordinate data, the operation instruction, the acceleration data and the motion data;
a first communication module coupled to the second microprocessor for receiving the two-dimensional coordinate data, the operation instruction, the acceleration data and the motion data and outputting the two-dimensional coordinate data, the operation instruction, the acceleration data and the motion data to the game console by the second communication method; and
a second memory coupled to the second microprocessor for storing the two-dimensional coordinate data, the operation instruction, the acceleration data and the motion data temporarily.

14. The control device of claim 8, wherein the touch panel is a panel of resistive, capacitance, optical and surface acoustic wave.

15. A two-dimensional input device suitable for communicating with a game console which performing a game program, the two-dimensional input device comprising:
a touch panel displaying a pattern corresponding to the game program;
a touch sense module coupled to the touch panel for generating a sense signal according to touch of the touch panel and outputting the sense signal;
an operation module for generating an operation instruction according to operation of user and outputting the operation instruction;
an acceleration sensor for generating an acceleration data according to motion of the remote controller and outputting the acceleration data;
an optical image processing circuit for filtering an outside light and performing an image processing with the outside light to obtain a motion data and output the motion data;
a core circuit coupled to the touch panel, the touch sense module, the optical image processing circuit, the operation module and the acceleration sensor for receiving the sense signal the acceleration data and the motion data, wherein the core circuit performs a coordinate operation with the sense signal to obtain a two-dimensional coordinate data for outputting the two-dimensional coordinate data, the operation instruction, the acceleration data and the motion data to the game console by a communication method.

16. The two-dimensional input device of claim 15, wherein the core circuit comprises:
a microprocessor coupled to the touch panel, the touch sense module, the optical image processing circuit, the operation module and the acceleration sensor, wherein the microprocessor performs a coordinate operation with the sense signal to obtain the two-dimensional coordinate data for outputting the two-dimensional coordinate data, the operation instruction, the acceleration data and the motion data;
a communication module coupled to the microprocessor for receiving the two-dimensional coordinate data, the operation instruction, the acceleration data and the motion data and outputting the two-dimensional coordinate data, the operation instruction, the acceleration data and the motion data to the game console by the communication method;
a memory for coupled to the microprocessor for storing the pattern, wherein the memory stores the two-dimensional coordinate data, the operation instruction, the acceleration data and the motion data temporarily.

17. The two-dimensional input device of claim 15, wherein the touch panel is a panel of resistive, capacitance, optical and surface acoustic wave.

18. A two-dimensional input device suitable for communicating with a game console which performing a game program, the two-dimensional input device comprising:
a game plugboard having a pattern corresponding to the game program;
a touch panel disposed under the game plugboard;
a touch sense module coupled to the touch panel for generating a sense signal according to touched of the pattern and outputting the sense signal;
an operation module for generating an operation instruction according to operation of user and outputting the operation instruction;
an acceleration sensor for generating an acceleration data according to motion of the remote controller and outputting the acceleration data;
an optical image processing circuit for filtering an outside light and performing an image processing with the outside light to obtain a motion data and output the motion data;
a core circuit coupled to the touch sense module, the optical image processing circuit, the operation module and the acceleration sensor for receiving the sense signal the acceleration data and the motion data, wherein the core circuit performs a coordinate operation with the sense signal to obtain a two-dimensional coordinate data for outputting the two-dimensional coordinate data, the operation instruction, the acceleration data and the motion data to the game console by a communication method.

19. The two-dimensional input device of claim 18, wherein the core circuit comprises:
a microprocessor coupled to the touch sense module, the optical image processing circuit, the operation module and the acceleration sensor, wherein the microprocessor performs a coordinate operation with the sense signal to obtain the two-dimensional coordinate data for outputting the two-dimensional coordinate data, the operation instruction, the acceleration data and the motion data;
a communication module coupled to the second microprocessor for receiving the two-dimensional coordinate data, the operation instruction, the acceleration data and the motion data and outputting the two-dimensional coordinate data, the operation instruction, the acceleration data and the motion data to the game console by the communication method; and
a memory coupled to the microprocessor for storing the two-dimensional coordinate data, the operation instruction, the acceleration data and the motion data temporarily.

20. The two-dimensional input device of claim 18, wherein the touch panel is a panel of resistive, capacitance, optical and surface acoustic wave.
